(19) United States
(12) Patent Application Publication
(10) Pub. No.: US 2026/0050328 A1
(43) Pub. Date: Feb. 19, 2026

(54) MIXED REALITY FACIAL INTERFACE WITH INTEGRATED BIOSENSORS

(71) Applicant: Meta Platforms Technologies, LLC, Menlo Park, CA (US)

(72) Inventors: Xiyu Duan, Sammamish, WA (US); Inigo Arnaiz Duenas, Snohomish, WA (US); Travis Taylor, San Jose, CA (US); Robert Bruce Darling, Lake Forest Park, WA (US); Benjamin Kurt Wilson, Snoqualmie, WA (US); Judy Hermann, Palo Alto, CA (US); Sudhir Mulpuru, Milpitas, CA (US); Jianwei Zhang, Westborough, MA (US)

(21) Appl. No.: 19/013,765

(22) Filed: Jan. 8, 2025

Related U.S. Application Data
(60) Provisional application No. 63/683,144, filed on Aug. 14, 2024.

(51) Int. Cl. G06F 3/01; G01L 5/22; G02B 27/00; G02B 27/01; G06V 40/16

(52) U.S. Cl. CPC G06F 3/015; G01L 5/22; G02B 27/0093; G02B 27/0176; G06V 40/172

(57) ABSTRACT

An apparatus of the subject technology includes a headset, a facial interface and a plurality of sensors. The facial interface is coupled to the headset and includes regions of differing stiffness. The sensors are integrated with the facial interface and include at least a pressure sensor and a photoplethysmography (PPG) sensor.

### CROSS-REFERENCE TO RELATED APPLICATIONS

The present disclosure is related and claims priority under 35 USC § 119(e) to US Provisional Application No. 63/683,144, entitled “MIXED REALITY FACIAL INTERFACE WITH INTEGRATED BIOSENSORS,” filed on August. 14, 2024, the contents of which are herein incorporated by reference, in their entirety, for all purposes.

### TECHNICAL FIELD

The present disclosure generally relates to mixed reality (MR) and more particularly, to an MR facial interface with integrated biosensors.

### BACKGROUND

Biosensors play a pivotal role in MR including virtual reality (VR) fitness applications by providing real-time feedback that enhances user experience and performance. These sensors can monitor various physiological parameters such as heart rate, body temperature, and muscle activity. By capturing this data, biosensors enable the VR system to adapt the workout intensity and provide personalized feedback, ensuring that users are exercising within their optimal zones. This real-time monitoring not only helps in maximizing the effectiveness of the workout but also in preventing injuries by alerting users when they are pushing their limits too far.

Moreover, the integration of biosensors in MR fitness applications creates a more immersive and engaging environment. For instance, the data collected can be used to simulate real-world conditions, such as adjusting the difficulty of a virtual trail based on the user's fatigue levels. This dynamic interaction makes the fitness experience more interactive and enjoyable, motivating users to stay committed to their fitness goals. Additionally, the feedback provided by biosensors can be used to track progress over time, offering users insights into their improvements and areas that need more focus. This continuous loop of feedback and adjustment fosters a more effective and personalized fitness regimen. However, none of the existing VR headsets have integrated biosensors, partly due to space constraint, cost, and different sensor location than wrist wearables.

### SUMMARY

According to some aspects, an apparatus of the subject technology includes a headset, a facial interface and a plurality of sensors. The facial interface is coupled to the headset and includes regions of differing stiffness. The sensors are integrated with the facial interface and include at least a pressure sensor and a photoplethysmography (PPG) sensor.

According to other aspects, a system of the subject technology includes a headset, a facial interface and a number of sensors. The facial interface is coupled to the headset and includes a stiff region and a compliant region. The sensors are coupled to the facial interface. At least some of the sensors are placed within the stiff region of the facial interface in contact with a forehead of a user.

According to yet other aspects, a method of the subject technology includes integrating a plurality of sensors with a facial interface and coupling the facial interface to a headset. The sensors include at least a pressure sensor and a PPG sensor, and the facial interface includes a stiff region used to support a weight of the headset and a compliant region.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram illustrating an example system architecture of a Bluetooth low energy (BLE)-based MR facial interface with integrated biosensors, according to some aspects of the subject technology.

FIG. 2 is a block diagram illustrating an example system architecture of a universal serial bus (USB)-based MR facial interface with integrated biosensors, according to some aspects of the subject technology.

FIG. 3 is a schematic diagram illustrating an example of a front-head blood-vessel distribution used to place sensors, according to some aspects of the subject technology.

FIG. 4 is a chart illustrating plots of example signal levels versus contact pressure used for pressure optimization.

FIG. 5 illustrates a first example use case in an MR (e.g., VR) fitness application, according to some aspects of the subject technology.

FIG. 6 is a diagram illustrating a second example use case in a home checkup system application, according to some aspects of the subject technology.

FIG. 7 is a schematic diagram illustrating an example embodiment of a facial interface, according to some aspects of the subject technology.

FIG. 8 is a schematic diagram illustrating an example embodiment of a facial interface, according to some aspects of the subject technology.

FIG. 9 is a schematic diagram illustrating an example embodiment of a facial interface, according to some aspects of the subject technology.

FIG. 10 is a flow diagram illustrating an example method of manufacturing an MR headset, according to some aspects of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the included clauses. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Some aspects of the subject disclosure are directed to an MR (e.g., VR) facial interface with integrated sensors. The sensors of the subject technology can be biosensors that are directly integrated into the MR facial interface. In some implementations, the disclosed techniques of the subject technology process the sensor signals in real time and send processed signals to the MR headset through a wired or wireless connection. Examples of the wired connection include a universal serial bus (USB) connection using a USB connector such as a USB-C connector. Examples of the wireless connection include Bluetooth connection or near field communication (NFC). In some embodiments, the sensors are assembled in a sensor module, for example, a removable capsule that can be inserted into or removed from the MR headset.

The disclosed facial interface is a smart facial interface with integrated sensors for sensing the state of the user. In some aspects, the disclosed smart facial interface can be used as an accessory that can be made available separate from the MR device without increasing the price of the MR device itself. In some implementations, the facial interface includes one or more of the following sensors: a photoplethysmography (PPG) sensor, pressure sensors, a temperature sensor, an accelerometer, a step counter, a body temperature sensor, a skin temperature sensor, an electrocardiogram (ECG) sensor, an electrooculogram (EOG) sensor, an electroencephalogram (EEG) sensor, an electrodermal activity (EDA) sensor (e.g., a sweat sensor), and a skin blushing sensor (for avatars). The PPG sensor is a low-cost, non-invasive sensor that utilizes optical techniques to detect changes in blood volume in the microvascular bed of tissue. The PPG sensor often is used to measure vital functions such as blood pressure, oxygen saturation, and heart rate at the surface of the skin.

In some implementations, the disclosed facial interface creates two areas of differing stiffness including a first region such as a surrounding stiff region that supports the weight of the headset, and a second region including a softer compliant region that allows any contact sensor modules to contact the user's face without restricting perfusion. The facial interface design includes a pressure/force sensor to notify users if the strap is too loose or too tight. The facial interface design includes an active component (e.g., a motor) to adjust the contact pressure of the sensor. The PPG sensor is placed on a user in a location based on blood vessel distribution on the forehead for optimal signal level. The optimal sensor location is determined by scanning a user's face to create a custom facial identification (FI). The sensor location is also determined by placing multiple sensors and selecting the ones with the best signal quality.

In some implementations, the facial interface uses the PPG sensor to turn on/turn off detection to distinguish skin from other objects. The facial interface is configured to monitor health indicators such as at least the heart rate (HR), heart rate variability (HRV), calories, oxygen saturation (SpO2), temperature, blood pressure (BP), respiration rate, stress, and/or sweat. In some implementations, the facial interface has the force/pressure sensor and the PPG sensor embedded into the stiff region of the headset in the front of the headset in the forehead.

The existing facial interfaces are either passive or contain additional battery to extend battery life of the headset. Also, it is possible to use existing technology, such as smart watches, to feed biosensor data into the MR device. Using the existing technology, however, may cause a user's reluctance of the adoption of the technology, for example, due to the need of additional hardware (HW) and pairing steps, as well as the lag due to communications between the smart watch and the MR headset. Furthermore, the wrist devices (e.g., smart watches) are more prone to motion artifacts during MR workouts.

The integration of biosensors into MR facial interfaces represents a significant advancement in wearable technology. These interfaces are designed to seamlessly blend the physical and digital worlds, providing users with immersive experiences. By incorporating biosensors, these devices can monitor physiological signals such as heart rate, skin temperature, and even brain activity. This data can be used to enhance user experiences by adapting the virtual environment in real time based on the user's physical state. For example, if the sensors detect increased stress levels, the system could adjust the environment to be more calming, thereby improving user comfort and engagement.

Moreover, MR facial interfaces with integrated biosensors have potential applications beyond entertainment and gaming. In healthcare, they can be used for remote monitoring of patients, providing real-time data to healthcare providers and enabling more personalized treatment plans. In professional training and education, these interfaces can create more effective learning environments by responding to the user's cognitive load and emotional state. The integration of biosensors also opens new possibilities for research in human-computer interaction, offering insights into how users interact with digital content on a physiological level. Overall, the combination of MR technology and biosensors is paving the way for more intuitive, responsive, and personalized digital experiences. The MR fitness is one of the areas heavily invested in, within which the Supernatural App was developed. This technology greatly enhances the MR fitness experience and can unlock new use cases such as real-time content adaptation. Other than fitness, the biosensors can also help augment avatars by changing avatar behavior based on biosensor input.

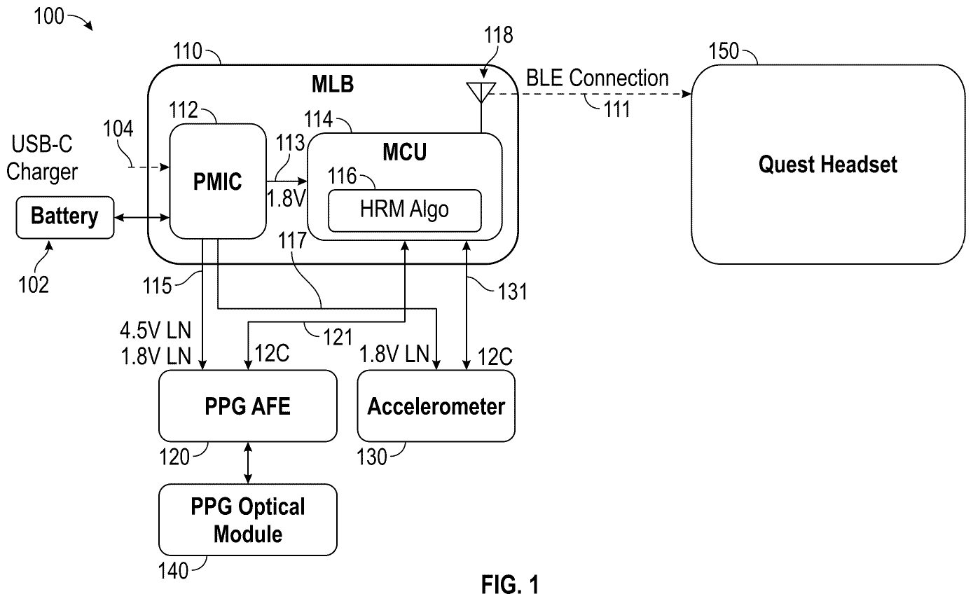

Turning now to the description of the figures, FIG. 1 is a block diagram illustrating an example system architecture of a BLE-based MR facial interface 100 with integrated biosensors, according to some aspects of the subject technology. The facial interface 100 is a separate unit that can be coupled to an MR headset 150 such as a Quest headset. In the example architecture of FIG. 1, the coupling between the facial interface 100 and the MR headset 150 is via a BLE connection 111 using a radiofrequency (RF) antenna 118. The facial interface 100 includes a main logic board (MLB) 110 that includes a power management integrated circuit (PMIC) 112, a microcontroller unit (MCU) 114 and the RF antenna 118. The MLB 110 is coupled via a USB-C cable 104 to a charger (not shown for simplicity) and/or hard wired to a battery 102 (e.g., a rechargeable battery). The PMIC 112 provides regulated operating voltage (e.g., 1.8V) for the MCU 114 via a connection 113 and for the accelerometer 130 via a connection 117.

The PMIC 112 is coupled via a connection 115 to a PPG analog front-end (AFE) 120, which in turn is connected to a PPG optical module 140. The MCU 114 includes a heart-rate monitoring (HRM) algorithm (Algo) 116 and is coupled via connections 121 and 131 to the PPG AFE 120 and an accelerometer 130, respectively. The PMIC 112 provides low noise (LN) voltages at two different levels, for example, 1.8V and 4.5V to the PPG AFE 120. The PMIC 112 also provides an LN voltage of about 1.8V to the accelerometer 130. The PPG AFE 120 includes analog and/or digital circuity that can control and read data from the PPG optical module 140. The PPG optical module 140 includes low-cost and non-invasive sensor that utilizes optical techniques to detect changes in blood volume in the microvascular bed of tissue. The PPG sensors are often used to measure vital functions such as blood pressure, oxygen saturation, and heart rate at the surface of the skin.

The accelerometer 130 is part of an IMU and plays a crucial role in tracking motion and orientation. For example, the accelerometer 130 can measure the rate of change in movement, allowing the MR system to detect the speed and direction of the movement. It can also combine data from three axes (x, y and z) to determine the MR headset orientation. The accelerometer 130, when integrated with sensors such as gyroscopes and magnetometers of the IMU, can help provide stable and accurate tracking, which ensures a smooth and immersive MR experience.

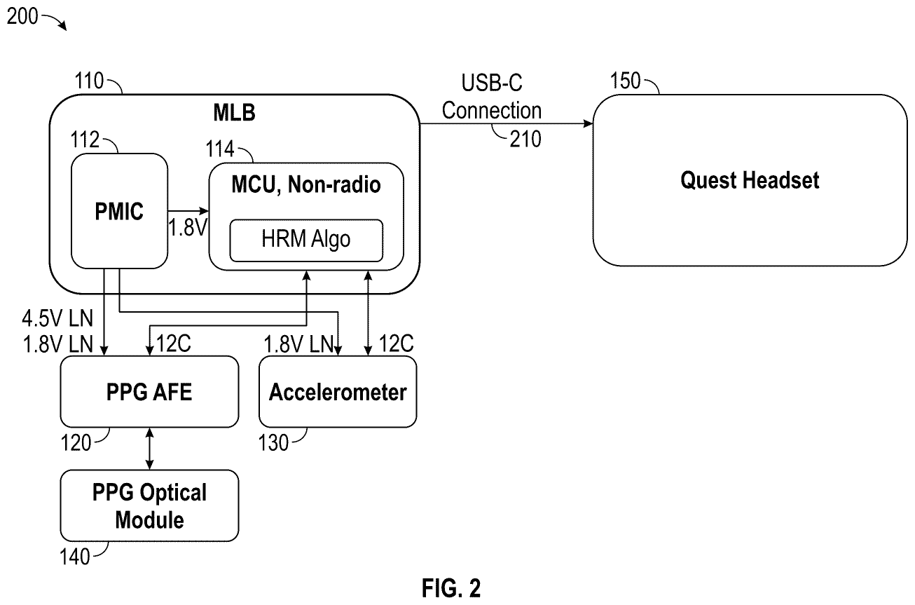

FIG. 2 is a block diagram illustrating an example system architecture of a USB-based MR facial interface 200 with integrated biosensors, according to some aspects of the subject technology. The example system architecture shown in FIG. 2 is similar to the architecture of FIG. 1, except that the MLB 110 has no RF antenna and is coupled, via a USB connector 210 (e.g., USB-C) to the MR headset 150 (e.g., Quest headset). In the implementation shown in FIG. 2, the MLB receives power through the USB connector 210 from the MR headset 150, thus there is no need for a separate connection to a battery or a charger. The functionality and connections of the PMIC 112, the MCU 114, the PPG AFE 120, the accelerometer 130 and the PPG optical module 140 are similar to the description provided with respect to FIG. 1.

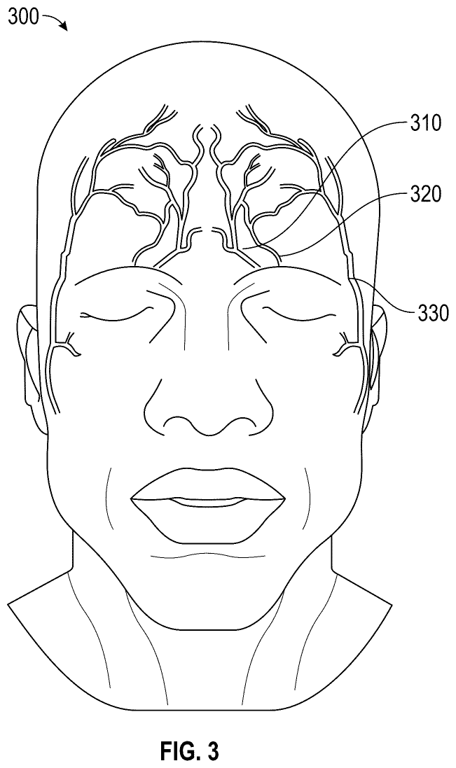

FIG. 3 is a schematic diagram illustrating an example of a front-head blood-vessel distribution 300 used to place sensors, according to some aspects of the subject technology. The front-head blood-vessel distribution 300 shown in FIG. 3 is used to scan the forehead for optimal signal level and includes a supratrochlear artery 310, a supraorbital artery 320 and a superficial temporal artery 330. The facial interface leverages the front-head blood-vessel distribution 300 to perform a face scan for each user and create a custom facial interface (FI) with an optimal sensor location. In some implementations, to find the optimal sensor location, multiple sensors are placed on the forehead and the sensors with the best signal (e.g., highest strength and/or lower interference) are selected.

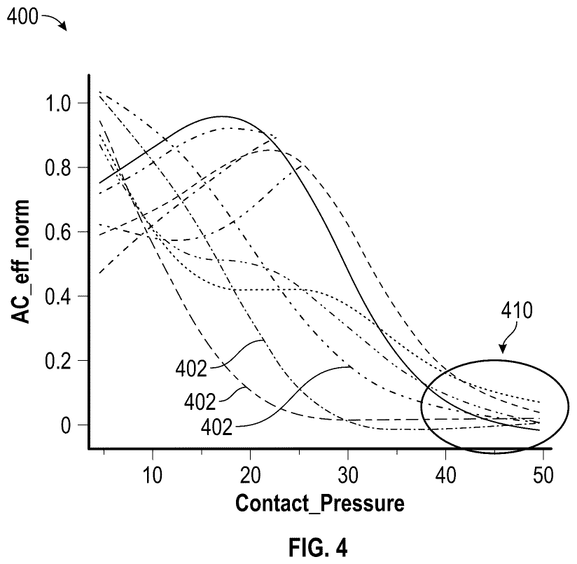

FIG. 4 is a chart 400 illustrating plots 402 of example signal levels versus contact pressure used for pressure optimization. The plots in the chart 400 are associated with different people and indicate that the sensitivity of blood flow or perfusion to contact pressure is significantly higher on the forehead compared to other parts of the body. The chart 400 can be used to design a mechanical device that can be used to optimize contact pressure for different users. In some implementations, a pressure or force sensor can be used to notify a user of a headset whether the headset strap is too loose or too tight. In the contact pressure range 410, which can be associated with a tight strap, the signal levels are unacceptably low. In some implementations, the facial interface design creates two areas of differing stiffness: a surrounding stiff region that supports the weight of the headset and a softer compliant region that allows the PPG module to float on the user's face without restricting perfusion.

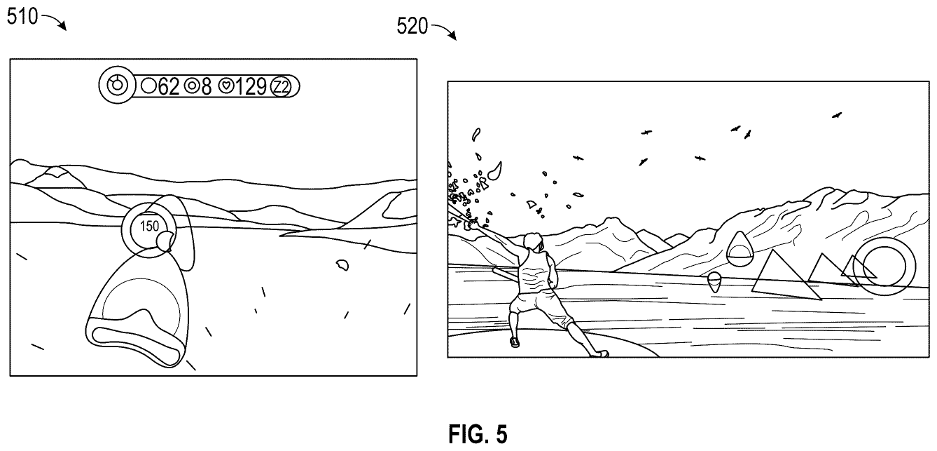

FIG. 5 illustrates diagrams depicting a first example use case in an MR (e.g., VR) fitness application, according to some aspects of the subject technology. In the fitness application, as shown, the headset may be used for a number of physical activities and sports, and the headset, as shown in diagram 510, can display calories burned, active minutes, HR and HR zone, while the user is engaged with the activity. Diagram 520 is a screenshot from a fitness application depicting a user wearing an MR (e.g., VR) headset of the subject technology while being engaged in a physical activity.

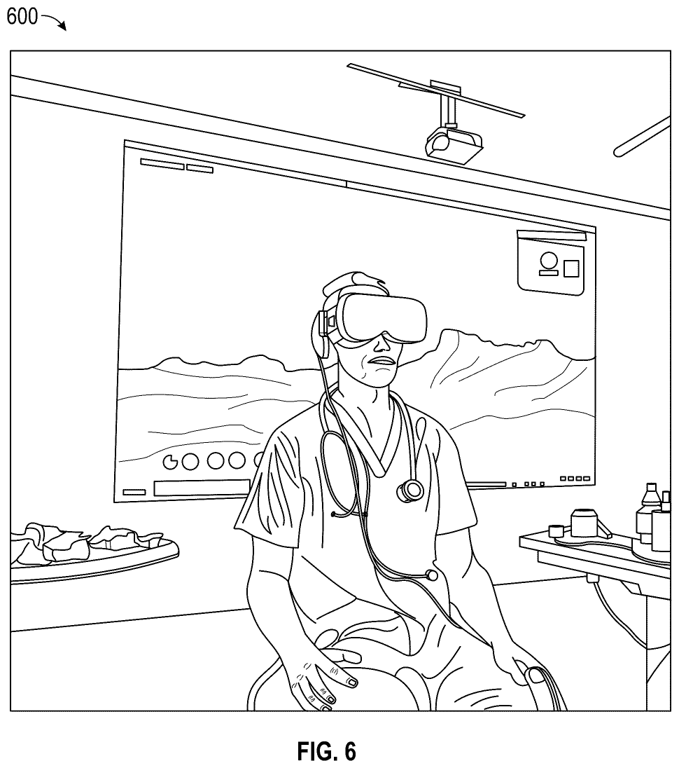

FIG. 6 illustrates a diagram 600 depicting a second example use case in a home checkup system application, according to some aspects of the subject technology. The facial interface of the subject technology can be used in telemedicine. As shown in diagram 600, the patient is wearing the MR (e.g., VR) headset of the subject technology and is shown in an arbitrary visual background, while attending a virtual hospital visit from home in a telemedicine session. In this visit, a remote health practitioner (e.g., a doctor or a nurse) also wears a similar MR headset, through which the practitioner can see health indicators such as HR, HRV, SPO2, BP, temperature and respiration, as measured by the MR headset, which is shared with the health practitioner.

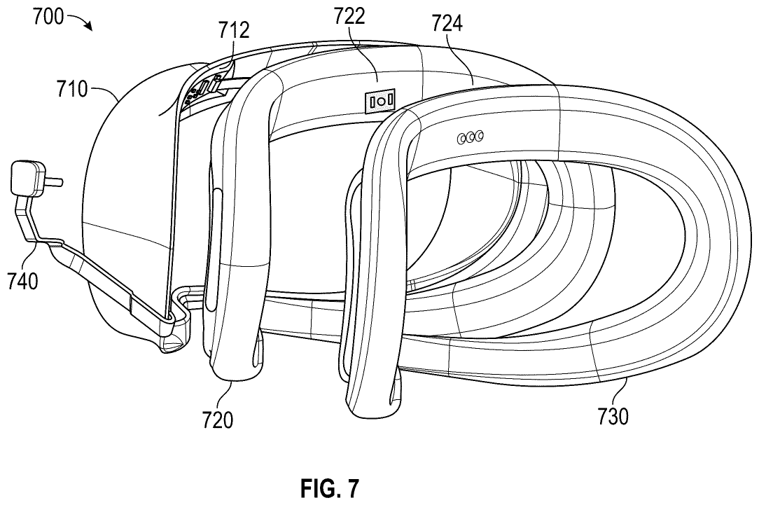

FIG. 7 is a schematic diagram illustrating an example embodiment of a facial interface 700, according to some aspects of the subject technology. The facial interface 700, as shown in FIG. 7, includes a plastic frame 710, a foam core 720 and a silicone outer skin 730. The plastic frame 710 includes a logic board 712 (e.g., MLB 110 of FIG. 1) that is connected via a ribbon cable to a PPG sensor 722, which is embedded in the foam core 720. Also, a sensor housing and windows 724 is provided in the silicone outer skin 730. The silicone outer skin 730 covers the foam core 720 and provides a softer compliant region that allows the PPG sensor 722 to contact the user's face without restricting perfusion. The foam core 720 is fitted with the plastic frame 710, which provides a USB cable 740.

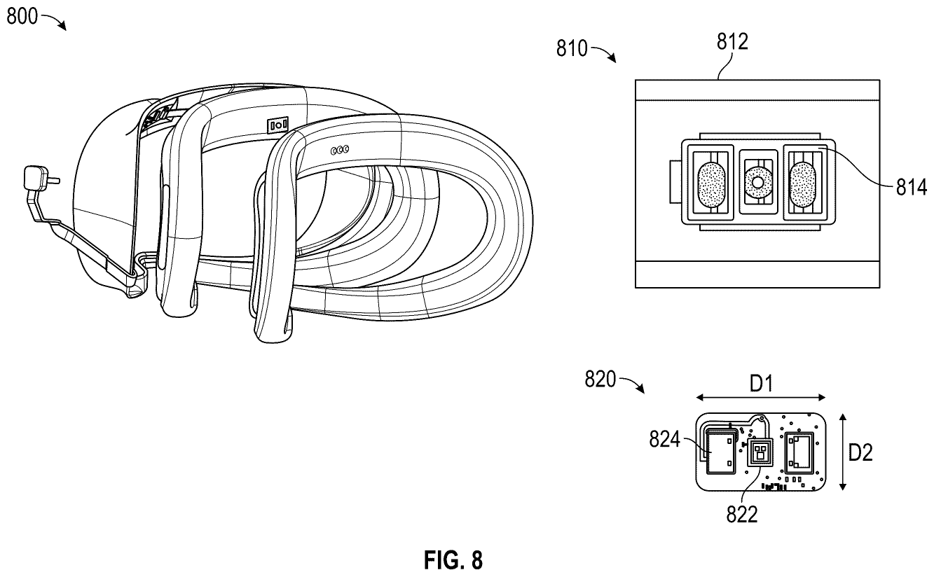

FIG. 8 is a schematic diagram illustrating an example embodiment of a facial interface 800, according to some aspects of the subject technology. The facial interface 800 is similar to the facial interface 700 of FIG. 7. The sensor design is depicted in diagrams 810 and 820. As shown in the diagram 810, the sensor module (e.g., PPG sensor 722 of FIG. 7) is embedded in a skin (e.g., made of silicone or other suitable material) 812 with optical isolation between sensor module components (e.g., a multi-wavelength LED and two photodiodes). Each component is embedded in a silicone window 814. The diagram 820 shows the sensor module including a multi-wavelength LED 822 and two photodiodes 824. In some implementations, values for dimensions D1 and D2 of the sensor module can be about 12 mm and 6 mm, respectively.

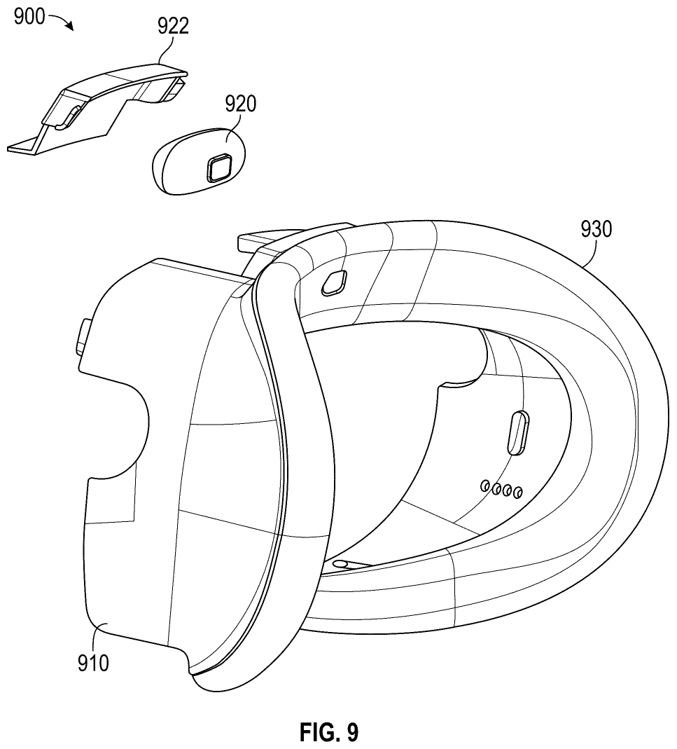

FIG. 9 is a schematic diagram illustrating an example embodiment of a facial interface 900, according to some aspects of the subject technology. The facial interface 900 is similar to the facial interface 700 of FIG. 7, except that the logic board 712 and the PPG sensor module 722 of FIG. 7 is replaced with a removable capsule 920 that can be inserted into or removed from the facial interface 900. Also shown in FIG. 9 are the plastic frame 910 and the silicone outer skin 930. In some implementations, the removable capsule 920 can include, but is not limited to, an MLB (e.g., 110 of FIG. 1), a PPG Module (e.g., including 120 and 140 of FIG. 1), an accelerometer (e.g., 130 of FIG. 1), a battery, and an RF antenna for BLE connection. The removable capsule is inserted into a cavity of the facial interface 900, which has a cover 922.

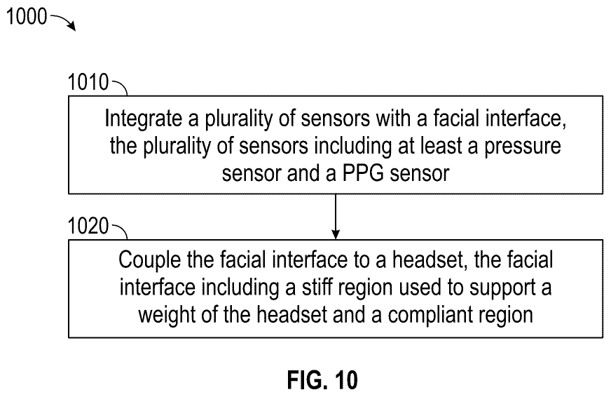

FIG. 10 is a flow diagram illustrating an example method 1000 of manufacturing an MR headset, according to some aspects of the subject technology. The method 1000 includes process steps 1010 and 1020.

In process step 1010, a plurality of sensors (e.g., 822 and 824 of FIG. 8) are integrated with a facial interface (e.g., 800 of FIG. 8). The plurality of sensors include at least a pressure sensor and a PPG sensor.

In process step 1020, the facial interface is coupled to a headset. The facial interface includes a stiff region (e.g., 710 of FIG. 7) used to support a weight of the headset and a compliant region (e.g., 730 of FIG. 7).

An aspect of the subject technology is directed to an apparatus that includes a headset, a facial interface and a plurality of sensors. The facial interface is coupled to the headset and includes regions of differing stiffness. The sensors are integrated with the facial interface and include at least a pressure sensor and a photoplethysmography (PPG) sensor.

In some implementations, the plurality of sensors further include a temperature sensor, an accelerometer, a step counter, a body temperature sensor and a skin temperature sensor.

In one or more implementations, the plurality of sensors further include an electrocardiogram (ECG) sensor, an electrooculogram (EOG) sensor, an electroencephalogram (EEG) sensor, an electrodermal activity (EDA) sensor, and a skin blushing sensor.

In some implementations, the regions of differing stiffness comprise a first region including a surrounding stiff region configured to support a weight of the headset.

In one or more implementations, the regions of differing stiffness comprise a first region including a surrounding stiff region configured to support a weight of the headset.

In some implementations, the pressure sensor included in the facial interface is configured to measure a contact pressure and notify a user to adjust a strap of the headset to reach a desired contact pressure.

In one or more implementations, the facial interface further includes an active component configured to adjust a strap of the headset to reach the desired contact pressure based on a signal from the pressure sensor, wherein the active component includes a motor.

In some implementations, the PPG sensor is placed on a location on a forehead of a user based on blood vessel distribution to increase a signal level of the PPG sensor.

In one or more implementations, the location on the forehead of the user is determined based on a facial identification (FI) created by scanning a face of the user or by placing multiple PPG sensors and selecting one or more PPG sensors with desired signal quality.

In some implementations, the facial interface is configured to monitor health indicators such as at least one of a heart rate (HR), a heart rate variability (HRV), calories, an oxygen saturation (SpO2), temperature, blood pressure (BP), respiration rate, stress, and sweat, and display a plurality of parameters including calories, an active time, a heart rate and a heart rate zone during a fitness activity.

In one or more implementations, the facial interface is configured to communicate with the headset via one of a Bluetooth low energy (BLE), or a communication interface including a universal serial bus type C (USB-C).

Another aspect of the subject technology is directed to a system that includes a headset, a facial interface and a number of sensors. The facial interface is coupled to the headset and includes a stiff region and a compliant region. The sensors are coupled to the facial interface. At least some of the sensors are placed within the stiff region of the facial interface in contact with a forehead of a user.

In some implementations, the compliant region is configured to allow one or more contact sensor modules to contact a face of the user without restricting perfusion, and wherein the contact sensor modules include at least some of the plurality of sensors.

In one or more implementations, the plurality of sensors comprise a pressure sensor, a PPG sensor, an ECG sensor, an EOG sensor, an EEG sensor, an EDA sensor, and a skin blushing sensor.

In some implementations, the PPG sensor is placed on a location on the forehead of the user based on a blood vessel distribution determined by an FI created by scanning the face of the user.

In one or more implementations, the PPG sensor is configured to distinguish skin from other objects.

In some implementations, the facial interface comprises a removable sensor capsule configured to be inserted into a cavity provided in front of the headset over the forehead of the user.

Yet another aspect of the subject technology is directed to a method including integrating a plurality of sensors with a facial interface and coupling the facial interface to a headset. The sensors include at least a pressure sensor and a PPG sensor, and the facial interface includes a stiff region used to support a weight of the headset and a compliant region.

In one or more implementations, the compliant region is used to allow one or more contact sensor modules to contact a face of a user without restricting perfusion, and the one or more contact sensor modules comprise at least some of the plurality of sensors.

In some implementations, the method further comprises coupling the facial interface to the headset by using one of a BLE or a communication interface including a USB-C interface, and determining a location for placing the PPG sensor on the facial interface based on a desired PPG signal level achieved while scanning a face of a user to determine a blood vessel distribution.

In some implementations, the word “exemplary” is used herein to mean “serving as an example, instance, or illustration. ” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more. ” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S. C. § 112, sixth paragraph, unless the element is expressly recited using the phrase “means for” or, in the case of a method clause, the element is recited using the phrase “step for. ”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking system. It should be noted that the subject technology enables fabrication of a depth-sensing apparatus that is a fully solid-state device with small size, low power, and low cost.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise”is interpreted when employed as a transitional word in a claim.

A reference to an element in the singular is not intended to mean “one and only one” unless specifically stated, but rather “one or more. ” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An apparatus, comprising:
a headset;
a facial interface coupled to the headset and including regions of differing stiffness; and
a plurality of sensors integrated with the facial interface,
wherein the plurality of sensors include at least a pressure sensor and a photoplethysmography (PPG) sensor.

2. The apparatus of claim 1, wherein the plurality of sensors further include a temperature sensor, an accelerometer, a step counter, a body temperature sensor and a skin temperature sensor.

3. The apparatus of claim 1, wherein the plurality of sensors further include an electrocardiogram (ECG) sensor, an electrooculogram (EOG) sensor, an electroencephalogram (EEG) sensor, an electrodermal activity (EDA) sensor, and a skin blushing sensor.

4. The apparatus of claim 1, wherein the regions of differing stiffness comprise a first region including a surrounding stiff region configured to support a weight of the headset.

5. The apparatus of claim 1, wherein the regions of differing stiffness further comprise a second region including a compliant region configured to allow one or more contact sensor modules to contact a face of a user without restricting perfusion.

6. The apparatus of claim 1, wherein the pressure sensor included in the facial interface is configured to measure a contact pressure and notify a user to adjust a strap of the headset to reach a desired contact pressure.

7. The apparatus of claim 6, wherein the facial interface further includes an active component configured to adjust a strap of the headset to reach the desired contact pressure based on a signal from the pressure sensor, wherein the active component includes a motor.

8. The apparatus of claim 1, wherein the PPG sensor is placed on a location on a forehead of a user based on blood vessel distribution to increase a signal level of the PPG sensor.

9. The apparatus of claim 8, wherein the location on the forehead of the user is determined based on a facial identification (FI) created by scanning a face of the user or by placing multiple PPG sensors and selecting one or more PPG sensors with desired signal quality.

10. The apparatus of claim 8, wherein the facial interface is configured to monitor health indicators such as at least one of a heart rate (HR), a heart rate variability (HRV), calories, an oxygen saturation (SpO2), temperature, blood pressure (BP), respiration rate, stress, and sweat, and display a plurality of parameters including calories, an active time, a heart rate and a heart rate zone during a fitness activity.

11. The apparatus of claim 1, wherein the facial interface is configured to communicate with the headset via one of a Bluetooth low energy (BLE), or a communication interface including a universal serial bus type C (USB-C).

12. A system, comprising:
a headset;
a facial interface coupled to the headset and including a stiff region and a compliant region; and
a plurality of sensors coupled to the facial interface,
wherein:
at least some of the plurality of sensors are placed within the stiff region of the facial interface in contact with a forehead of a user.

13. The system of claim 12, wherein the compliant region is configured to allow one or more contact sensor modules to contact a face of the user without restricting perfusion, and wherein the contact sensor modules include at least some of the plurality of sensors.

14. The system of claim 13, wherein the plurality of sensors comprise a pressure sensor, a PPG sensor, an ECG sensor, an EOG sensor, an EEG sensor, an EDA sensor, and a skin blushing sensor.

15. The system of claim 14, wherein the PPG sensor is placed on a location on the forehead of the user based on a blood vessel distribution determined by an FI created by scanning the face of the user.

16. The system of claim 14, wherein the PPG sensor is configured to distinguish skin from other objects.

17. The system of claim 12, wherein the facial interface comprises a removable sensor capsule configured to be inserted into a cavity provided in front of the headset over the forehead of the user.

18. A method, comprising:
integrating a plurality of sensors with a facial interface; and
coupling the facial interface to a headset,
wherein:
the plurality of sensors include at least a pressure sensor and a PPG sensor, and
wherein the facial interface includes a stiff region used to support a weight of the headset and a compliant region.

19. The method of claim 18, wherein:
the compliant region is used to allow one or more contact sensor modules to contact a face of a user without restricting perfusion, and
the one or more contact sensor modules comprise at least some of the plurality of sensors.

20. The method of claim 18, further comprising:
coupling the facial interface to the headset by using one of a BLE or a communication interface including a USB-C interface; and
determining a location for placing the PPG sensor on the facial interface based on a desired PPG signal level achieved while scanning a face of a user to determine a blood vessel distribution.
